(19) United States
(12) Patent Application Publication
(10) Pub. No.: US 2006/0265273 A1
(43) Pub. Date: Nov. 23, 2006

(54) System and method of facilitating the sale of a component of a product

(76) Inventor: Mark A. Nottoli, Lake Bluff, IL (US)

Correspondence Address: Bell, Boyd & Lloyd LLC, P.O. Box 1135, Chicago, IL, 60690-1135, US

(21) Appl. No.: 11/133,587

(22) Filed: May 19, 2005

(51) Int. Cl. G07G 1/00; G06F 17/30

(52) U.S. Cl. 705/10

(57) ABSTRACT

Systems and methods of facilitating the sale of a component of a product are provided. In one embodiment of the present invention, a turnkey nutritional product is provided by an ingredient supplier to a manufacturer of a nutritional product that incorporates that ingredient. The ingredient supplier also includes with the product, substantially, all the marketing information and customized branding support necessary to market the product. The packaging and labeling of the product is compliant and sufficiently complete to allow the manufacturers or other downstream providers of the product to receive the product in a form ready to be sold to the consumer in turnkey fashion.

### BACKGROUND

The present invention generally relates to systems and methods of selling a component of a product.

Most products are composed of a combination of parts, ingredients, raw materials or other basic components. The components of the products are often sold by separate suppliers of those individual components to a third party, such as a manufacturer who incorporates those components into a finished product. For example, a supplier of peanuts may sell peanuts to a manufacturer of candy bars to be incorporated into the candy bar product. The manufacturer of candy bars may purchase from a different supplier another component, such as chocolate, to be incorporated into the candy bar product.

A component of a product is typically sold to a manufacturer in a raw, fungible form that is not specific to any particular product and is not distinguishable from any other substantially identical component sold by other suppliers. For example, a supplier of peanuts may sell peanuts to a manufacturer of candy bars to be incorporated into the candy bar product. Furthermore, the same supplier of peanuts may sell peanuts to a manufacturer of peanut butter to be incorporated into the peanut butter product. Moreover, a manufacturer of candy bars may supplement or replace its supply of peanuts by purchasing peanuts from another supplier of peanuts. Therefore, an interchangeable component of a product sold by a supplier often lacks features that distinguish that component from substantially the same component sold by other suppliers. Consequently, a supplier of a component of a product has very little on which to base any marketing of that component to a third party.

FIG. 1, for example, illustrates how a product incorporating a component sold by a supplier is typically prepared to be sold to a consumer. In FIG. 1, three different suppliers, supplier A 10a, supplier B 10b and supplier C 10c, sell an interchangeable component 26 to multiple third parties, third party A 12a, third party B 12b, and third party C 12c. Each third party 12 purchases a component 26 from any one of the suppliers 10 and incorporates or integrates all of the necessary components, including the component 26, into a finished product. Specifically, third party A 12a incorporates the component 26 into product 30a along with other components 28a; third party B 12b incorporates the component 26 into product 30b along with other components 28b; and third party C 12c incorporate the component 26 into product 30c along with other components 28c. It should be appreciated that product 30a can be the same or similar product as product 30c.

Although, a finished product may include all of its necessary components, the finished product may exist in an unprepared form, that is, the product is not ready to be sold directly to the consumer. A finished product that has been assembled, formulated or otherwise produced, requires further preparation before it can be sold to a consumer. Specifically, a finished product is often at least branded, packaged, labeled and otherwise prepared for the market. Therefore, before a product can be presented to a consumer, the product must be prepared to be sold to a consumer. Preparation of a product for the market may include, for example, acquiring information related to the product, branding the product, preparing collateral materials to market the product and providing resources to support the product.

Typically, preparing the product for the market is not the responsibility of the supplier of a component of the product but rather the responsibility of a third party that prepares the product to be sold to a consumer such as the manufacturer of the product. Accordingly, as further illustrated in FIG. 1, third party A 12a acquires information related to the product 16a, brands the product 18a, prepares collateral materials to market the product 20a and provides resources to support the product 22a. Similarly, third party B 12b acquires information related to the product 16b, brands the product 18b, prepares collateral materials to market the product 20b and provides resources to support the product 22b. Likewise, third party C 12c acquires information related to the product 16c, brands the product 18c, prepares collateral materials to market the product 20c and provides resources to support the product 22c. The third parties 12 may then sell the finished product directly to a consumer 14 or to another entity, such as a distributor, with whom the third party has established a relationship or has authorized to further prepare the products to be sold to the consumer.

Besides branding, labeling and packaging a product, preparing the product to be sold to the consumer includes determining how to incorporate components into the finished product and gathering information about the components of the product. Information about a component of a product is especially important when that component is an active ingredient of the product. The information obtained about the components of the product is used to market the product to the consumer, and, once the product has been sold to the consumer, the information related to the product is used to support the product.

Preparing a product for the market and providing information about the product to consumers becomes more complex when the product or its components are regulated, such as by a government agency. In this regard, the third party must comply with specific regulations regarding the preparation of the product for market and the information disseminated with the product. For example, the Food and Drug Administration (FDA) of the United States government has enacted certain guidelines for products such as pharmaceuticals, nutraceuticals, nutritional supplements and foodstuffs.

Furthermore, for products that are not prescribed by a physician or dispensed by a pharmacist, the need for providing a consumer with sufficient information to make an informed choice of whether to consume the product and how to consume the product is especially acute. In addition, much of the information concerning regulated products and their components is scientifically based and is subject to ongoing research. Accordingly, product information for such products and their components is subject to change and/or requires updating over the immediate course of the life of the product in the marketplace. Safety information and new indications of use of these products may be frequently determined and, therefore, must need to be collected and disseminated in a responsible way.

In many cases more than one third party is involved in preparing a product to be sold to a consumer. A third party such as a manufacturer of a product, for example, must often rely on out-sourcing to fulfill different aspects of preparing a product for market and providing adequate product information to the consumer. The manufacturer may out-source the responsibility to distributors, packers, marketing firms, advertising firms or other specialized downstream providers that contribute to preparing the product to be sold to the consumer. The applications, benefits, formulation possibilities, science regulations and other complex issues associated with preparing a product to be sold to the consumer may not often be familiar to or readily available to entities involved in preparing a product to be sold to a consumer. Therefore, manufacturers and other entities involved in preparing a product to be sold to a consumer may not always be in a position to provide comprehensive marketing and support of a product. In addition, involving multiple third parties in the preparation of a product to be marketed to a consumer can result in additional costs and loss of standardization or control of product branding, product information and collateral materials provided with the product.

### SUMMARY

The present invention relates to systems and methods of selling a component of a product. In particular, the present invention relates to systems and methods of facilitating the sale of a component of a product by to a third party providing a product incorporating the component that is substantially ready to market to a consumer.

In an embodiment of the present invention, a method is provided of facilitating the sale of a component of a product by a supplier of the component to a third party involved in preparing the product to be sold to a consumer, wherein the component is typically sold by the supplier to said third party separate from the product is provided. The method includes presenting to the third party a product substantially prepared to be sold to a consumer. The supplier associates the component with the product, brands the product, and includes the product branding in collateral materials provided with the product.

In an embodiment, the component of the product includes an active ingredient of the product.

In an embodiment, the product includes a regulated product.

In an embodiment, the product includes a nutritional product.

In an embodiment, the supplier associates the component with the product by preparing the component to be incorporated into a product.

In an embodiment, the supplier associates the component with the product by incorporating the component into the product.

In an embodiment, the supplier associates the component with the product by providing at least one method for incorporating the component into the product.

In an embodiment, the supplier prepares a prototype of the product sold by the third party.

In an embodiment, the supplier customizes the product for the third party.

In an embodiment, the supplier labels the product, the labeling including the product branding.

In an embodiment, the supplier provides information related to the product in the collateral materials provided with the product.

In an embodiment, the collateral materials include materials to market the product to a consumer.

In an embodiment, the supplier provides support for the product.

In an embodiment, the supplier includes branding of the third party in the collateral materials.

In an embodiment, the supplier provides the collateral materials through at least one medium selected from the group consisting of: a publication, software, data network and combinations thereof.

In an embodiment, the method includes facilitating the sale of a right in the component.

In another embodiment of the present invention, a marketing system for selling a component by a supplier of the component to a third party, wherein the component has been sold separate from a product incorporating the component is provided. The system includes a finished product associated with the component; and collateral materials associated with the product. The collateral materials include branding of the product. The finished product and collateral materials are presented to the third party to facilitate the sale of the component to the third party.

In an embodiment, the collateral materials include product labeling.

In an embodiment, the collateral materials include marketing materials.

In an embodiment, the collateral materials include support materials.

In an embodiment, the collateral materials include intellectual property protection of the product and the product branding.

In an embodiment, the system includes a source for the collateral materials.

In an embodiment, the source includes a location on a data network.

In yet another embodiment of the present invention, a method of marketing a component of a nutritional product to a manufacturer of the nutritional product is provided. The method includes formulating a nutritional product including the component, branding the nutritional product, preparing collateral materials associated with the nutritional product. The branding of the nutritional product is incorporated into the collateral materials. The collateral materials include product claims that comply with any regulations related to the claims. The method also includes presenting for sale to the manufacturer of the nutritional product the nutritional product with the collateral materials.

In an embodiment, the component of the nutritional product includes an active ingredient of the nutritional product.

In yet a further embodiment of the present invention, a method of associating a fungible component of a product with the product is provided. The method includes selling to a manufacturer of the product the fungible component incorporated into the product wherein the product is substantially prepared to be sold to a consumer.

In yet a further embodiment of the present invention, a method of distinguishing a component of a product sold by a first supplier to a third party from the component of the product sold by a second supplier to the third party is provided. The method includes presenting to the third party a product substantially prepared to be sold to a consumer. The first supplier associates the component with the product, brands the product, and includes the product branding in collateral materials provided with the product.

In an embodiment, the supplier incorporates the component into the product.

It is, therefore, an advantage of the present invention to facilitate the sale of a component of a product to a third party by a supplier of that component.

Another advantage of the present invention is to facilitate the sale of a component of a product to a third party by a supplier of that component by facilitating the subsequent sale of that component by the third party.

An additional advantage of the present invention is to enable a supplier of a component of a product to provide a third party purchaser of the component a product associated with the component that is substantially prepared to be marketed to a consumer.

Another advantage of the present invention is to enable a supplier of a component of a product to provide a third party purchaser of the component branding of a product incorporating the component.

A further advantage of the present invention is to enable a supplier of a component of a product to provide a third party purchaser of the component comprehensive collateral materials with a product incorporating the component.

Yet an additional advantage of the present invention is to enable a supplier of a component of a product to provide collateral materials customized for a third party purchaser of the component to accompany the product incorporating the component.

Yet another advantage of the present invention is to enhance the quality and reliability of information about a product provided to a third party.

Another advantage of the present invention is to enable a supplier of a component of a product to control and standardize the information communicated to the consumer about the product incorporating that component.

Yet a further advantage of the present invention includes efficiently reporting new indications of use of products and product safety information.

An even further advantage of the present invention is to enable a supplier of a component to establish a proprietary position in a product incorporating the component.

Another advantage of the present invention includes creating market exclusivity in a component sold by a particular supplier.

A further advantage of the present invention includes associating a component of a product sold by a particular supplier of that component with a particular product.

Yet another advantage of the present invention includes decreasing the overall cost of preparing a product to be sold to the consumer.

Additional features and advantages of the present invention are described in, and will be apparent from, the following Detailed Description of the Invention and the figures.

### BRIEF DESCRIPTION OF THE FIGURES

FIG. 1 is a diagram illustrating steps of preparing a product to be sold to consumers performed by a third party.

FIG. 2 is a diagram illustrating different substantially prepared products prepared by the supplier to be sold to respective third parties in at least one embodiment of the invention.

FIG. 3 is a diagram illustrating the general steps in the preparation of a product for marketing to a consumer in at least one embodiment of the present invention.

FIG. 4 is a diagram generally illustrating an example of a label of a product in at least one embodiment of the present invention.

### DETAILED DESCRIPTION

The present invention relates to systems and methods of selling a component of a product. In particular, the present invention relates to systems and methods of selling to a third party a component of a product that is typically sold alone without being incorporated into a finished product. The systems and methods of the present invention include facilitating the sale of an ingredient, raw material or basic component of a product to a third party. To facilitate the sale of the component to the third party, the component may be associated into a product that is substantially prepared to be sold to a consumer. To this end, a substantially complete product package is presented to a third party which includes the component associated with a prototype product, product branding, and any collateral materials that contribute to preparing the product to be sold to a consumer. In an embodiment, the product package may be customized for the third party.

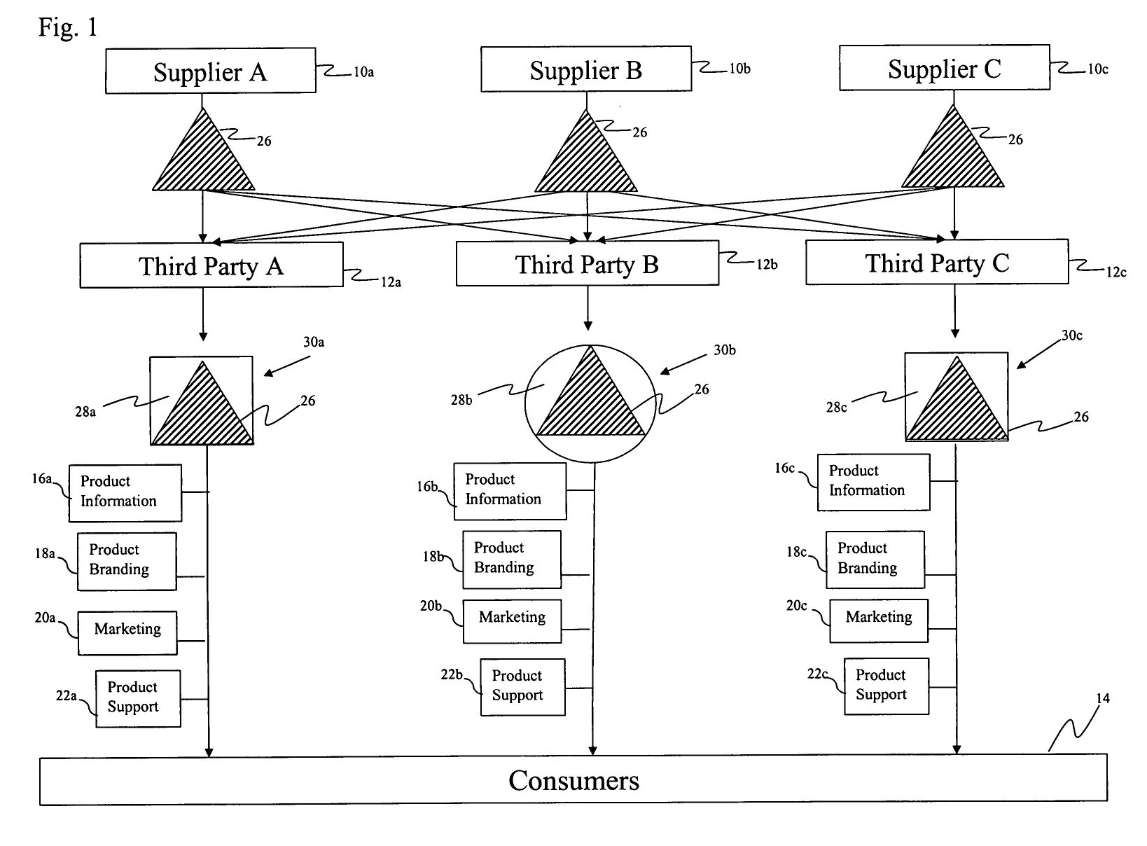

As discussed above, a supplier of a component of a product sells the component to at least one third party, such as a manufacturer, that incorporates the component into a product. In contrast to the scenario illustrated in FIG. 1, however, the systems and methods of the present invention are directed to a supplier of an ingredient, raw material or basic component of a product that substantially prepares the component to be sold to the consumer to facilitate the sale of the component to a third party. The supplier of the component may present for sale to the third party the component itself, and/or a right to the component such as a right to make, use or sell the component. For example, the supplier may attempt to license to a third party the right to make, use or sell a patented component.

As used herein, the term, “supplier”, can refer to any provider of an ingredient, raw material or basic component that is incorporated into a product. The supplier may include any entity in a supply chain responsible for providing to a third party a component of that product. Accordingly, the supplier may include an entity that has purchased the component from at least one other supplier, and may include an entity that sells the component to at least one third party, one of which sells the component to a manufacturer that makes the finished product.

As used herein, the term, “component” can refer to any part, ingredient, raw material, or element of a product that is ultimately incorporated or integrated into the product such as an ingredient of a nutritional product. The component may be in a form that is heretofore typically sold alone or separate from a product incorporating the component by a supplier of the component. To this end, the component is not usually sold in a form that is integrated into the product or otherwise included with the product. Additionally or alternatively, the component may be in a raw form that is, at least in part, unprocessed requiring further processing or adaptation to be incorporated into a product. Additionally or alternatively, the component may be in a form that is fungible having properties essentially identical to properties of other components such that the components are interchangeable for commercial purposes.

The component may be a primary component of the product or an active ingredient of that product. As used herein, “active ingredient” refers to any component of a product that is intended to provide a substantial contribution to the function, utility or specified effect of that product. In a product administered to the body for purposes of entering the body, such as a pharmaceutical, nutraceutical, nutritional supplement or nutritional product, the active ingredient may include any component that affects the structure or any function of the body of man or of animals. For example, in a pharmaceutical, the active ingredient furnishes pharmacological activity or other direct effects in the diagnosis, cure, mitigation, treatment, or prevention of a condition, or otherwise. The component may also undergo a physical or chemical change before, during or after the manufacture of the product and may be present in the product in a modified form intended to furnish the specified activity or effect.

As used herein, the term “third party” can refer to any purchaser of a component or right to the component of a product. A third party can include, but is not limited to, a manufacturer, distributor, further supplier, marketer, packager, dealer, contractor, trader, seller, purveyor, broker, vendor, wholesaler, retailer or any other downstream provider that is involved in advancing a product to the market.

In an embodiment, the supplier of a component of a product facilitates the sale of the component by associating the component with the product and presenting the component associated with the product to a third party that purchases the component. Associating a component with a product may include incorporating the component into the product, providing information on how to incorporate the component into a product or any other act of developing a product that uses the component. As used herein, the term “incorporating” can refer to any process of assimilating, mixing, amalgamating, formulating, combining the component with other components, if any, or adapting, further processing or otherwise preparing the component to make the finished product.

In one embodiment of the present invention, the supplier of the component of a product associates the component with the product by demonstrating the use of the component in the product. To this end, the supplier of the component may identify a product in which the component can be incorporated. The supplier of the component may prepare an actual viable, efficacious prototype or sample of a product or formulation that includes the component. The prototype product may be an existing product made or distributed by the third party. Alternatively, the prototype product may be a proposed product that highlights or showcases the use of the component in a new product. Presenting the product to the third party with the component associated into the product by the supplier of the component enables the third party to visualize an actual prototype of an existing or new product incorporating the component and the utility of the component in the product to market and facilitate the sale of that component. Moreover, a substantial portion of the development of the product may be completed for the third party, thereby saving the cost and time associated with such development.

Additionally or alternatively, the supplier may disclose or provide information including how the component can be used or incorporated into a viable, efficacious product or formulation. To this end, the supplier may provide the third party with at least one method of using or incorporating the component into the product and may or may not provide an actual prototype or sample of a product incorporating the component. It should be appreciated that a supplier of a component of a product may be in an advantageous position to know applications, formulation possibilities, benefits and science of the component to know how to incorporate that component into a finished product.

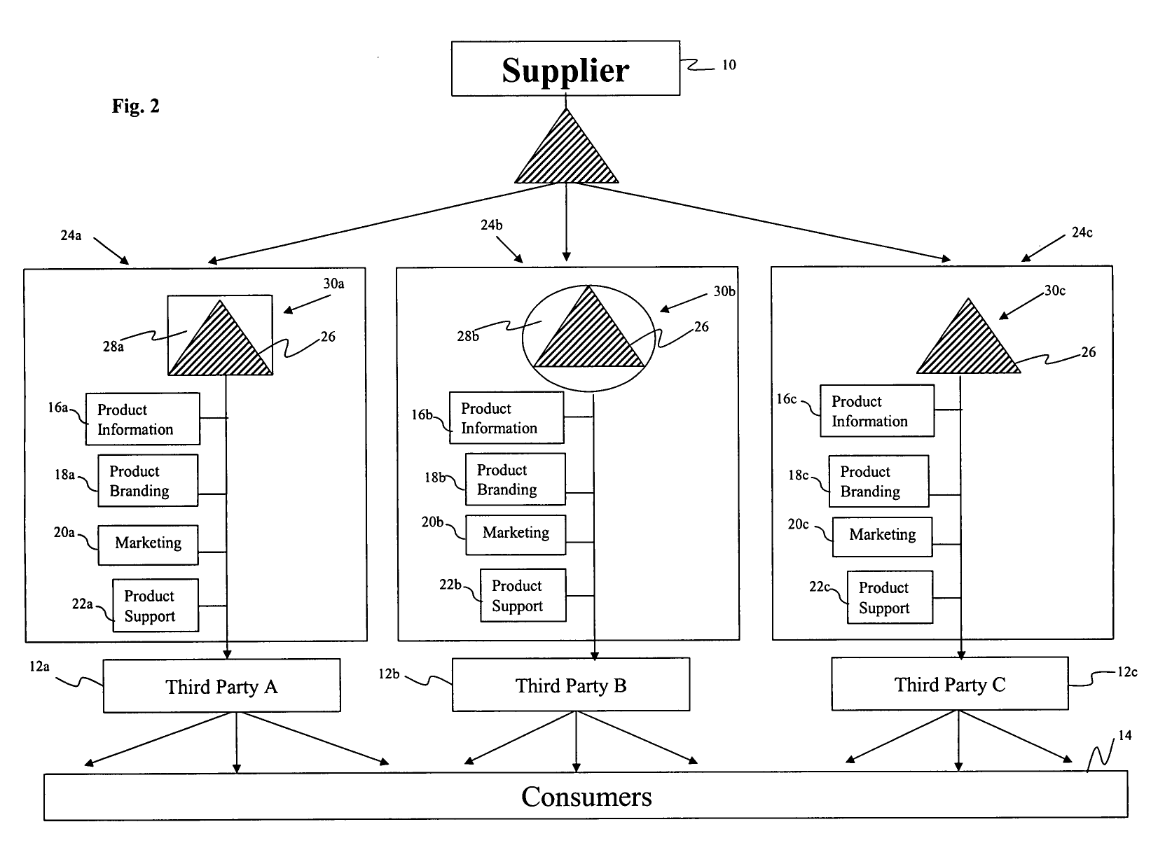

Accordingly, as illustrated in FIG. 2, one embodiment of the present invention includes a supplier 10 of a component 26 incorporating the component 26 into three different products 30a, 30b and 30c. The supplier 10 can incorporate the component 26 into a prototype product 30a customized to be presented to third party A 12a. Similarly, the supplier 10 can incorporate the component 26 into a prototype product 30b customized to be presented to third party B 12b. The products may include any number of other components from the same or different suppliers. For example, products 30a and 30b can include other components 28a and 28b, respectively.

In addition, the supplier may modify or adapt the component to be sold as a product by a third party. As illustrated in FIG. 2, for example, the supplier 10 can incorporate the component 26 into a prototype product 30c that includes no other components and that is customized to be presented to third party C 12c.

Alternatively, the supplier may prepare a single finished product prototype to be presented for sale to more than one third party. In any of the embodiments, the third party may further modify or adapt the component to be incorporated into its product or selectively incorporate elements of the prototype presented by the supplier into the finished product. It should be appreciated that by providing to a third party a prototype product incorporating the component, the time and cost associated with advancing that product to market should be significantly reduced. These advantages enable the supplier to distinguish its component from components sold by other suppliers to facilitate the sale of the component while allowing a third party to save the time and cost of developing, producing, manufacturing and/or formulating the product.

Before a finished product that has been produced or manufactured can be sold to a consumer, the product must be prepared to be marketed to the consumer. To this end, the systems and methods of the present invention include presenting for sale to at least one third party a component of a product that is typically provided separate from the product but has been substantially prepared by the supplier to be sold directly to a consumer to facilitate the sale of the component. Therefore, in addition to presenting a finished product prototype to a third party, the supplier may further prepare the product to be sold to a consumer. Preparing a product to be sold to a consumer can involve acquiring information related to the product, branding the product, preparing collateral materials to market the product and providing resources to support the product. The supplier can then present to each third party a substantially complete product package which includes an associated product that is substantially prepared to be sold to a consumer. It should be appreciated that by preparing a complete product package according to the systems and methods of the present invention, the supplier can provide to a third party or consumer more than just a service related to a product. The supplier is proactively facilitating the sale of that product.

In an embodiment, the supplier presents the third party with collateral materials associated with the product, including marketing and support materials. In one embodiment, these collateral materials are customized for a particular third party. For example, as illustrated in FIG. 2, the supplier 10 provides third party A 12a a substantially complete product package 24a that, in addition to the prototype product 30a, includes product information 16a, product branding 18a collateral materials 20a and product support 22a, each customized to be sold by third party A 12a. Likewise, the supplier 10 provides third party B 12b a substantially complete product package 24a that, in addition to the prototype product 30b, includes product information 16b, product branding 18b collateral materials 20b and product support 22b, each customized to be sold by third party B 12b. The supplier 10 also provides third party C 12c a substantially complete product package 24c that, in addition to the prototype product 30c, includes product information 16c, product branding 18c collateral materials 20c and product support 22c, each customized to be sold by third party C 12c. It should be appreciated that, if given a choice between a component of a product that is already developed, branded, marketed and supported and a product or component that is not, the third party purchaser of that component will be more inclined to purchase a turnkey product. Therefore, substantially preparing the product incorporating the offered component to be sold to a consumer enables the supplier of the component to further distinguish its component from components sold by other suppliers to facilitate the sale of the component.

One of the steps of preparing a product for the market may include branding the product. Accordingly, the systems and methods of the present invention include presenting a component for sale to a third party in the form of a product that is branded. In addition, the supplier of the component may include branding of the product in the collateral materials associated with the product incorporating the component. The supplier of the component may also sell or license the right to use branding that is owned by the supplier such as branding that is under trademark or copyright protection. To this end, in any of the embodiments, the supplier may secure intellectual property protection for the branding of the product. For example, patent, trademark and/or copyright protection can be obtained.

A product is branded by creating and establishing an overall identity or perception of the product that distinguishes the product from other products. Branding of a product may include a name, slogan, symbol, color schemes, graphics, shapes, sounds or any other suitable audio, visual or other sensory media or combinations thereof that convey an overall look or feel or attitude associated with the product.

In an embodiment, the supplier creates a brand name for the product. The brand name may include at least one name, letter, word, logo, symbol, design and/or any other representative indicia or combination thereof that identifies and distinguishes the product. The brand name may be descriptive of the product or include combinations of words, symbols or parts thereof that describe or inform the consumer about the product.

In addition, in an embodiment, the supplier may create or use a slogan, motto, jingle or any other unique selling proposition for the product. To this end, the branding of the product by the supplier includes creating or determining a unique selling proposition that informs the target consumer of the benefits provided by the product and/or how the product is distinguished from the competition.

In another embodiment, the supplier may create a symbol, logo or image that represents the product. The symbol, logo or image may deliver or convey an impression or message about the product that may or may not be consistent with the unique selling proposition discussed above.

Pursuant to the present invention, in an embodiment, branding of the product may include performing market research. Accordingly, the present invention may include a product in which a market or market niche is identified for the product by market research. Market research can also be performed to make other determinations about marketing the product such as determining how to differentiate the product from products of competitors and determining the needs and desires of a target consumer. The market research can include market analyses directed to providing information and product comparison related to the products of competitors. Other market research may be directed to determining pricing of the product based on consumer perception of quality and value along with determining competitor pricing.

In an embodiment, branding of the product may include developing at least one marketing strategy to effectively position the product in the market. The product can be positioned to address particular needs and desires of a consumer and/or to build an awareness of the product brand. For instance, in one embodiment, the supplier provides a product having an associated marketing strategy that includes a proposed marketing budget in terms of actual costs or allocation percentage, marketing targets such as various advertising media, product pricing and discounting schemes and any other suitable elements of a marketing strategy.

Another fundamental step of preparing a product for the market is to provide information about the product itself or related to the product. Accordingly, the systems and methods of the present invention include enabling the supplier to provide information about a product or its components with the product prototype presented to a third party. This step may be part of, or in addition to, the step of branding the product. Information related to the product or its components must be acquired, managed, interpreted and effectively communicated. When new information becomes available about a product or its components, that new product information must also be acquired, managed, interpreted and effectively communicated. This is especially true when the component provided by the supplier is an active ingredient of the product.

In addition to branding information, product information may also include information about the product and its components such as indications for use, instructions for use of the product with different indications, safety information and the like. Other product information may include any information used to market or support the product.

The product information provided with the product by the supplier may be acquired from a number of different sources of information. In one embodiment, the supplier compiles results and data from various scientific studies or testing related to the product or any of its components. Such product-related information can include information generated from research and development efforts of the supplier and information generated by sources other than the supplier such as academic, industrial and government research and testing.

In an embodiment directed to an ingredient of a nutritional product, for example, the product information may include detailed information about the ingredient including physical and chemical data and information, physiological specifications, safety information and clinical data. Product information may also include clinical pharmacology, pharmacokinetics, and results of clinical studies. The product information may be related to the active component of the product as defined above or any derivatives, metabolites, isomers, or any variant thereof. The product information may also be related to other components of the product or their derivatives, metabolites, isomers, or any variants thereof.

Chemical information may include the chemical structures and the empirical formula of each of the component molecules of the product and any structural or geometric isomers, derivatives or metabolites thereof. In addition, the chemical information can include the chemical form of the product such as a salt, an acid, an ester, etc. The chemical information can also include physical and chemical properties such as molecular weight, boiling point, melting point, pH, and the like.

Information related to physiological specifications, safety information and clinical data may include results of studies of mechanisms, effects of the product or its components or any other information that is material to the use of the product. Other clinical data can include clinical pharmacology, pharmacokinetics, and other results of clinical studies. It should be appreciated that the detailed information related to the components of a product may aid the supplier in developing the prototype product incorporating the component to be presented to a third party.

Furthermore, the product information may include detailed information of indications and usages as well as contraindications, interactions with other substances, warnings, precautions and adverse reactions. Product information may include recommended dosaging and methods of administration of the product. The information can also include dosaging tailored for various uses of the product or consumer-specific parameters such as age, sex, race, size, pre-existing medical conditions, and the existence of concurrent use of other drugs and/or medical devices.

Other product information may include practical guidance to the consumer for various uses and applications of the product. In an embodiment, the product incorporating the component sold by the supplier is not only provided with information on the actual use of the product, but is provided with information on how the product can be incorporated into a comprehensive wellness program. For example, the product may be incorporated into a diet and/or exercise program tailored or customized to the needs or lifestyle of the consumer.

In an embodiment, the supplier assimilates, analyzes and interprets the collected product information to formulate at least one voluntary statement about the product or its components in the form of a product claim. A product claim may include, for example, what the product is and what the product can do based on the information acquired about the product.

The product claims can also include any information material to the effective use and/or marketing of the product. For example, based on product testing, the supplier may formulate a nutritional claim for a nutritional product. The nutritional claim can include active ingredients, strength(s) and dosage form(s). Other information in the nutritional claim can include an appropriate serving size and a list of the ingredients. The list of ingredients may include the amount of each ingredient per serving size by weight and percent of daily value and energy in units such as calories associated with the serving size. Furthermore, if the product contains a proprietary blend of ingredients, the total weight of the blend and the identity of each component of the blend may be listed by weight. In addition, non-dietary ingredients may also be listed by weight.

In one embodiment, the supplier formulates a health claim for the product or its components. A health claim indicates a relationship between the product and reducing the risk of a particular disease or health-related condition. For example, a health claim of a nutritional product may include a statement that the product may reduce the risk of heart disease.

In one embodiment, the supplier formulates a structure/function claim for the product or its components. A structure/function claim is an assertion that the product may affect the structure or function of organs or systems of the body without mentioning a disease. For example, a structural function claim of a nutritional product may include a statement that the product may be beneficial for the heart.

In one embodiment, the supplier formulates other claims related to the product or its components. Other product claims can include, for example, statements about the product of particular interest to a consumer based on acquired product information or market research. In addition, these statements can include information related to other products and/or other components of products and how those products and/or other components of products compare to the prepared product and/or its components.

New information about the product or its components may become available even after the product has been distributed for sale. In fact, for some products, much of the information is scientifically based and is subject to ongoing research. Safety information and new indications of use are being determined continuously and need to be collected and disseminated. Therefore, product information for such products is subject to refinement and supplementation based on ongoing research and broader use of the product. In addition, new product information can contribute to the formulation of new product claims materials including new indications of use of the product, new dosing requirements, authorization for new product claims from regulatory agencies and/or intellectual property rights. Accordingly, in an embodiment, the supplier continues to obtain product information to be used to update and/or supplement the product information even after the component of the product has been sold to a third party. It should be appreciated that there is also an economic incentive for both the supplier and any third party involved with the product to readily communicate any new uses indicated for the product and its components and any new approvals or authorizations granted by regulatory agencies.

Product information can be regulated such that information provided with the product incorporating the component must be approved by the government or a regulatory agency. In addition, some product information is required to be provided with the product. In particular, information related to products that are administered to and enter the body as well as the information being disseminated with these products undergo a considerable amount of regulation by the government. A drug product, for example, that claims to diagnose, cure, mitigate, treat or prevent a disease is required by the FDA to have corroborated and standardized scientific evidence supporting the claims in order to gain approval for entry into the market. To this end, the systems and methods of the present invention include the supplier providing product information that is compliant with any regulations certifications, seals or other compliance issues related to the product or its components. In addition, the supplier may obtain any approvals related to the product or its components necessary to sell the product to a consumer. These approvals can include, without limitation, regulatory approval, legal approval, approval of the U.S. or any other foreign government, etc.

With respect to drug products, product information is not only provided to a third party and other downstream providers to be passed along to consumers, but the product information may be provided to physicians who prescribe the products and pharmacists who dispense the products prior to the product being made available to the consumer.

Other products administered to and entering the body that are not prescribed by a physician or dispensed by a pharmacist, such as nutritional products, are often made available to the consumer without the guidance of a professional. Therefore, the consumer relies on available sources of information to make an informed choice of whether to administer the product and how to administer the product. Accordingly, the FDA also regulates marketing and support information for nutritional products such as nutraceuticals, nutritional supplements and foodstuffs. Marketing and support information of the product, for example, may be required to include a statement of identity of the product, a net quantity of the contents, a structure-function claim, directions for use, supplement facts, other ingredients in descending order of predominance and by common name or proprietary blend, and name and place of business of the product or supplier or manufacturer.

Also, certain claims such as health claims and structure/function claims require certain standards to be met for the claim to be included in the marketing and support information accompanying the product. For example, in order for a health claim to be included in the marketing and support information accompanying a product, the supplier may petition the FDA to consider if the totality of publicly available scientific evidence supports the claim. The health claim must be supported by credible scientific evidence from well-designed studies based on generally-recognized standards of scientific principles and procedures. Additionally, the FDA must determine that there is significant scientific agreement among qualified experts of such a claim. Unlike the health claim, structure/function claims do not require approval by the FDA for the claim to be included on the product label. The supplier, however, may inform the FDA of the claim to be used and must include a disclaimer on the label notifying the consumer that the FDA has not evaluated the claim and that there is no relationship between the product and a disease. Therefore, the supplier of a component of a nutritional product may provide product information that is necessary to support claims made about the product or its components in compliance with the appropriate regulatory agency.

It should be appreciated that enabling a supplier of a component to control and standardize the information communicated to the consumer about the products incorporating that component may enhance the quality and reliability of information related to the products.

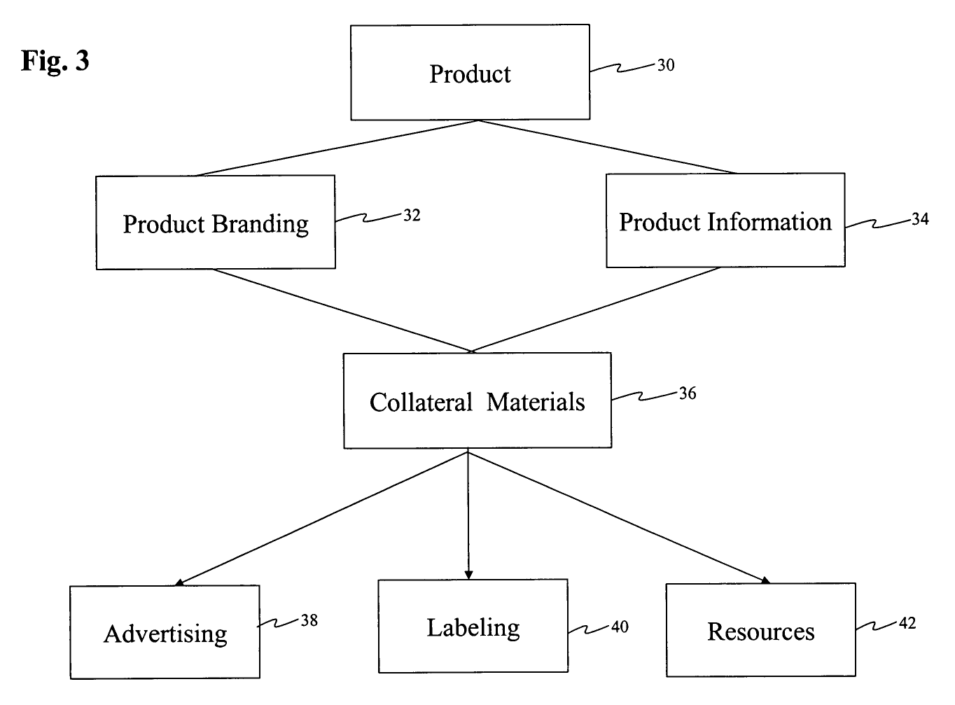

In order for the product of the present invention to be substantially prepared for the market, the product branding and product information to be used to market the product must be incorporated in the materials accompanying and associated with the product. To this end, the systems and methods of the present invention include the supplier of the component providing collateral materials with a product incorporating the component that is sold to a third party. As used herein, collateral materials refer to any form of communication that is provided with the product or is associated with the product. Collateral materials may include branding of the product, labeling, packaging, trade dress, information related to the product and any other medium, written, electronic or otherwise, for marketing and supporting the product. Accordingly, as illustrated in FIG. 3, the supplier incorporates branding of the product 32 and information related to the product 34 into collateral materials 36 provided with the product 30. The collateral materials 36 may further include labeling of the product 38, advertising of the product 40 and support resources dedicated to the product 42.

In an embodiment, the supplier provides collateral materials with the product that include information related to a third party associated with the preparation of that product. In this regard, the supplier may customize or tailor the collateral materials for each manufacturer that makes the product or for each distributor that distributes that individual product unit. For example, as described above and as illustrated in FIG. 2, the supplier 10 may provide collateral materials associated with an individual product unit sold by the supplier 10 to third party A 12a that are customized for third party A 12a. Collateral materials provided with an individual product unit sold by the supplier to third party B 12b are customized for third party B 12b, etc. In this regard, the collateral materials associated with a product customized for the third party can include any representative indicia of the third party including the name, logo, trademark or any other word, symbol or indicia that identifies the third party.

Other information provided with the product may also be customized for the third party. For instance, pricing and contact information may be provided on the label. In addition the supplier may provide collateral materials including any branding of the third party. It should be appreciated that providing branding support of a product that incorporates the branding of the third party allows the supplier to take advantage of any established goodwill of the third party that would prompt consumer brand recognition of the product.

The product marketing and support provided by the supplier may also include comprehensive marketing and support of the brand name of the product. In this regard, the supplier of a component of a product may provide collateral materials which include at least advertising materials, labeling, and resources to market and support the product. In one embodiment, the supplier incorporates product branding and product information in collateral materials directed to advertising the product. Advertising of the product can include any communication related to the product such as letterhead, business cards, e-mails, invoices, promotions and any other suitable materials associated with advertising the product. The advertising materials may be adapted to be disseminated through networking, direct mail marketing, media advertising, direct personal selling, web site, internet advertising and any other suitable mechanism for advertising a product.

In one embodiment, the supplier incorporates product branding and product information in collateral materials in the form of labeling of the product. As used herein, the labeling of a product refers to any display of written, printed, or graphic matter on the immediate container of a product or accompanying the product. For example, labeling can include container labels, packaging, package inserts, brochures, booklets, electronic media, mailing pieces, detailing pieces, file cards, bulletins, calendars, price lists, catalogs, house organs, letters, motion picture films, film strips, lantern slides, sound recordings, exhibits, literature, and reprints and similar pieces of printed, audio, or visual matter provided by a supplier or third party and which are disseminated by or on behalf of the supplier or third party.

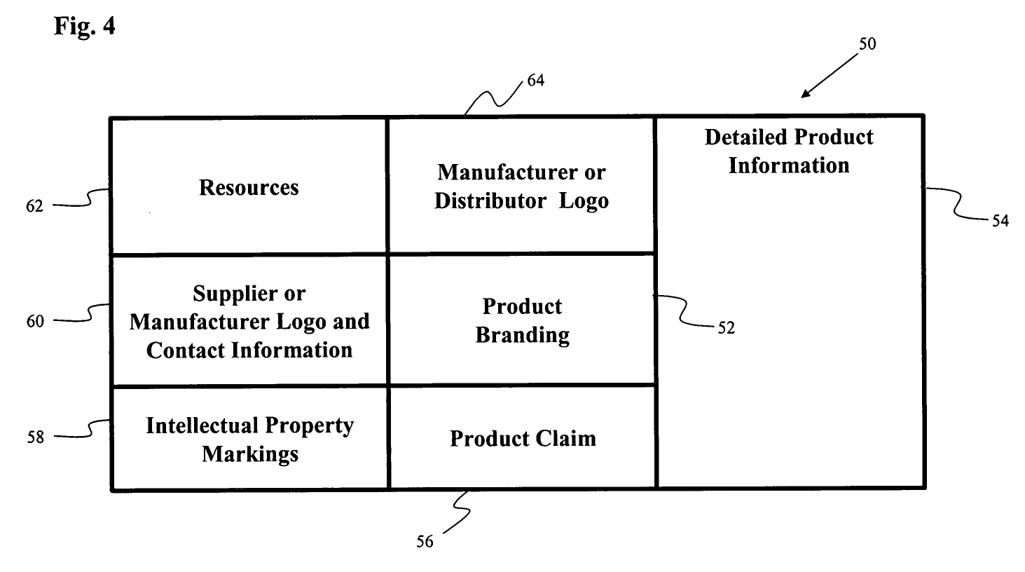

As illustrated in FIG. 4, in one embodiment of the present invention, the supplier provides product branding and product information on at least one label 50. Specifically, the label includes the brand name of the product 52, detailed product information 54, at least one product claim 56, intellectual property markings 58, component supplier information 60, and resources 62 for additional information related to the product.

As discussed above, the branding of the product 52 can include any names, words, characters, symbols or other indicia in addition to any color schemes, shapes or other graphics that represent the product. Detailed product information 54 can include, for example, a listing of the contents of the package or container including a nutritional claim or other product- or component-related details. A product claim 56 can include, for example, a health claim, structure/function claim or any other product claim to inform the consumer or attract the consumer to the product. Intellectual property markings 58 can include, for example, indications of pending patents, patent numbers, trademark registrations, copyright markings or any other markings related to property rights associated with the product. The supplier or manufacturer logo and contact information 60 can include, for example, supplier branding, location of business, phone number, electronic mailing address and other information a consumer can use to contact the supplier or other third party involved with the product. Resources dedicated to providing information about the product 62 can include, for example, a website, contact information to request additional information and other sources of information related to the product. In one embodiment, the product label includes information related to the manufacturer or distributor 64 or any other third party. As discussed above, the supplier may customize or tailor each label specifically for the third party. It should be appreciated that the information provided on the label of the product can be arranged in any suitable format, layout or position.

In addition to the labeling of the product provided by the product supplier with the product, the collateral materials of the present invention may include further custom and branded collateral materials. The further custom and branded collateral materials may be incorporated into resources such as publications, websites or any other suitable form or medium for communicating product branding and information related to the product.

The resources may be specifically directed to the product or its components. The resource may also include any information provided in the product labeling as discussed above. In addition, the resources may include legal and regulatory information and status of intellectual property. The resources may be updated periodically or as needed when, for instance, new product information becomes available.

In one embodiment, the resource includes a publication. The publication can be in paper form, electronic form or any other suitable form of communication. The publication may include, and is well-suited to provide, detailed information about the product and support information. In addition, the publication may include a “consumer-friendly” publication which includes human interest articles, facts and other product information provided to the consumer as part of the overall collateral materials provided with the product.

In one embodiment, the publication includes a technical manual which provides technical manufacturing specifications and scientific information about the product. For example, the supplier may provide a technical manual with a nutritional product. The technical manual may include chemical, physiological, pharmacological, safety and clinical data as discussed above. In such an embodiment, the technical manual may be routinely or automatically made available to a third party and not provided to the consumer unless requested by the consumer. For example, if the product is regulated or controlled, such as a drug, the resource may be provided to a physician, pharmacist or other health care professional who directs the use of the product in addition to the manufacturer of the product.

In an embodiment, collateral materials provided by the supplier include a resource available at a location on a data network such as a website on the internet. In one embodiment, the website is specifically directed to an individual product, a component of the product, the supplier and/or a third party. To this end, branding of the individual product, component part of the product, a component of the product, the supplier, and/or a third party is incorporated into the environment of the website. Accordingly, the website may have a web address specific to the individual product, component of the product, supplier and/or a third party. For example, a web address for product A produced by manufacturer A may be: www.productAmanufacturerA. Alternatively, a website dedicated to an individual product or component part of the product may be linked or may direct a consumer to the supplier or third party's website.

In addition, the website of the present invention may provide additional collateral materials for support of the product that are unique to the capabilities of electronic communication media. For example, the website may prompt the third party or consumer for user information enabling the supplier to correspond with the third party or consumer when updated product information becomes available, such as a new indication of use. Therefore, the supplier may disseminate updated information, passively by postings to a web site. In addition or alternatively, the supplier may disseminate the updated information actively by sending to subscribers electronic mail or alerts to consult the website for updated information. In such an embodiment, the supplier may send electronic-mail to the third party and/or consumer notifying them of the updated information or providing a link to the location of the new information.

In an embodiment of the present invention the supplier hosts an electronic forum which enables interactive communication between the supplier and the third party and/or consumer. In such an embodiment, the third party or consumer may be able to post a product question or comment electronically to the website for an answer or response from the supplier and/or third party and/or consumers.

Other features of the product marketing and support website of the present invention include practical guidance for applications of the product including general health and well-being resources. For example, a diet and/or exercise program incorporating the product may be included on the website. The website may present the wellness plan or program in a form that can be downloaded electronically from the server controlling the product website to the individual computer of the third party or consumer.

It should be appreciated that providing product branding, product information and collateral materials used to market and support a product sold to a third party enables a supplier of the component of that product to establish a unique proprietary position in the product and to exercise extended control over the success of the product in the marketplace. Additionally, the component can become associated with that product such that the product is exclusively prepared and marketed with the component sold by the particular supplier of that component.

In exchange, each third party receives a product from the supplier that is substantially prepared to be directly marketed to the consumer in a “turn-key” fashion. Consolidating the substantial preparation of the product in the supplier can contribute to reducing the overall cost to the third party of preparing the product to be sold to the consumer including the cost of developing, branding, marketing and supporting the product.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method of facilitating the sale of a component of a product by a supplier of said component to a third party involved in preparing the product to be sold to a consumer, wherein the component is typically sold by the supplier to said third party separate from the product comprising:
presenting to the third party a product substantially prepared to be sold to a consumer wherein the supplier
(a) associates the component with the product,
(c) brands the product, and
(d) includes said product branding in collateral materials provided with the product.

2. The method of claim 1, wherein the component of the product includes an active ingredient of the product.

3. The method of claim 1, wherein the product includes a regulated product.

4. The method of claim 3, wherein the product includes a nutritional product.

5. The method of claim 1, wherein the supplier associates the component with the product includes the supplier preparing the component to be incorporated into a product.

6. The method of claim 1, wherein the supplier associates the component with the product includes the supplier incorporating the component into the product.

7. The method of claim 1, wherein the supplier associates the component with the product includes the supplier providing a method for incorporating the component into the product.

8. The method of claim 1, wherein the supplier prepares a prototype of the product sold by the third party.

9. The method of claim 1, wherein the supplier customizes the product for the third party.

10. The method of claim 1, wherein the supplier labels the product, said labeling including the product branding.

11. The method of claim 1, wherein the supplier provides information related to the product in the collateral materials provided with the product.

12. The method of claim 1, wherein the collateral materials include materials to market the product to a consumer.

13. The method of claim 1, wherein the supplier provides support for the product.

14. The method of claim 1, wherein the supplier includes branding of the third party in the collateral materials.

15. The method of claim 1, wherein the supplier provides the collateral materials through at least one medium selected from the group consisting of: a publication, software, data network and combinations thereof.

16. The method of claim 1, which includes facilitating the sale of a right in the component.

17. A marketing system for selling a component by a supplier of said component to a third party, wherein the component has been sold separate from a product incorporating said component comprising:
a finished product associated with the component; and
collateral materials associated with the product, wherein the collateral materials include branding of the product and wherein the finished product and collateral materials are presented to the third party to facilitate the sale of the component to the third party.

18. The system of claim 17, wherein the collateral materials include product labeling.

19. The system of claim 17, wherein the collateral materials include marketing materials.

20. The system of claim 17, wherein the collateral materials include support materials.

21. The system of claim 17, wherein the collateral materials include intellectual property protection of said product and the product branding.

22. The system of claim 17, which includes a source for the collateral materials.

23. The system of claim 22, wherein the source includes a location on a data network.

24. A method of marketing a component of a nutritional product to a manufacturer of the nutritional product comprising:
formulating a nutritional product including the component;
branding the nutritional product;
preparing collateral materials associated with the nutritional product, wherein the branding of the nutritional product is incorporated into said collateral materials and wherein the collateral materials include product claims that comply with any regulations related to said claims; and
presenting for sale to the manufacturer of the nutritional product the nutritional product with the collateral materials.

25. The method of claim 26, wherein the component of the nutritional product includes an active ingredient of the nutritional product.

26. A method of associating a fungible component of a product with the product comprising
selling to a manufacturer of the product the fungible component incorporated into the product wherein the product is substantially prepared to be sold to a consumer.

27. A method of distinguishing a component of a product sold by a first supplier to a third party from the component of said product sold by a second supplier to the third party comprising:
presenting to the third party a product substantially prepared to be sold to a consumer wherein the first supplier
(a) associates the component with the product,
(c) brands the product, and
(d) includes said product branding in collateral materials provided with the product.

28. The method of claim 27, wherein the supplier incorporates the component into the product.
